(19) United States
(12) Patent Application Publication
(10) Pub. No.: US 2016/0146141 A1
(43) Pub. Date: May 26, 2016

(54) METHOD OF STARTING AN INTERNAL COMBUSTION ENGINE OPERATED WITH A FUEL-AIR MIXTURE

(71) Applicant: GE Jenbacher GmbH & Co OG, Jenbach (AT)

(72) Inventors: Johann HIRZINGER-UNTERRAINER, Koessen (AT); Herbert KOPECEK, Schwaz (AT); Hang LU, Freising (DE); Michael WALDHART, Telfs (AT)

(21) Appl. No.: 14/925,201

(22) Filed: Oct. 28, 2015

(30) Foreign Application Priority Data
Nov. 24, 2014 (AT) A 846/2014

(51) Int. Cl. F02D 41/06; F02D 41/26

(52) U.S. Cl. CPC F02D 41/062; F02D 41/263

(57) ABSTRACT

A method of starting an internal combustion engine operated with a fuel-air mixture, in particular a stationary gas engine, wherein fed to the internal combustion engine as part of the fuel-air mixture is a fuel volume flow which is ascertained having regard to at least one parameter which is characteristic of the energy content of the fuel-air mixture, wherein the internal combustion engine is driven by a starter device until the internal combustion engine continues to run of its own accord, wherein the fuel volume flow fed to the internal combustion engine is varied by a variation in the at least one parameter which is characteristic of the energy content of the fuel-air mixture until the internal combustion engine continues to run of its own accord.

The invention concerns a method of starting an internal combustion engine operated with a fuel-air mixture, in particular a stationary gas engine, wherein fed to the internal combustion engine as part of the fuel-air mixture is a fuel volume flow which is ascertained having regard to at least one parameter which is characteristic of the energy content of the fuel-air mixture, wherein the internal combustion engine is driven by a starter device until the internal combustion engine continues to run of its own accord.

In a starting operation for an internal combustion engine operated with a fuel-air mixture the internal combustion engine is fed with a fuel-air mixture including a fuel volume flow and air and driven by a starter device until the internal combustion engine continues to run of its own accord. In that case the magnitude of the fuel volume flow is frequently ascertained having regard to at least one parameter which is characteristic of the energy content of the fuel-air mixture like for example the stoichiometric air requirement or minimum air requirement Iₘᵢₙ in relation to the fuel or the combustion air ratio lambda of the fuel-air mixture. As an internal combustion engine usually starts with a lambda value of 1.2 that characteristic parameter is frequently set to the value of 1.2. The minimum air requirement is dependent on the fuel used and thus, when using a fuel gas as the fuel, is linked to the gas quality. Provided that the gas quality is known therefore the appropriate value for the minimum air requirement can be taken into consideration when ascertaining the fuel volume flow.

If however the gas quality or essential characteristic parameters which are relevant to the energy content of the fuel-air mixture are not known it can happen that, with the selected parameter values, the internal combustion engine does not start or is operated in an unfavorable operating mode.

Therefore the object of the invention is to provide a method of starting an internal combustion engine operated with a fuel-air mixture, that is improved over the state of the art. In particular the invention seeks to provide that the proposed method also permits reliable starting of the internal combustion engine, even with a fuel or fuel gas of unknown quality.

According to the invention that object is attained by the features of claim 1. Advantageous configurations of the invention are recited in the appendant claims.

According to the invention it is therefore provided that the fuel volume flow fed to the internal combustion engine is varied by a variation in the at least one parameter which is characteristic of the energy content of the fuel-air mixture until the internal combustion engine continues to run of its own accord.

The variation in the at least one parameter which is characteristic of the energy content of the fuel-air mixture (for example minimum air requirement or combustion air ratio) provides that the internal combustion engine starts reliably although the quality of the fuel and thus the calorific value of the fuel is initially not known.

In a particularly preferred embodiment it can be provided that a minimum air requirement is varied in relation to the fuel as the parameter which is characteristic of the energy content of the fuel-air mixture.

It can also be provided that a combustion air ratio of the fuel-air mixture is varied as the parameter which is characteristic of the energy content of the fuel-air mixture.

In a preferred embodiment of the invention it can be provided that the at least one parameter which is characteristic of the energy content of the fuel-air mixture is varied starting from a predeterminable starting value. The variation in the parameter can logically take place in the appropriate limits relevant to the corresponding category of fuel. When using fuel gas as the fuel for example suitable ranges for the variation in the minimum air requirement Iₘᵢₙ for natural gas are between 9 and 10, for biogas between 6 and 10 and for mine gas between 3 and 10. In the case of fuel gas therefore it can be provided in particular for those examples that, starting from a starting value of 10 for the minimum air requirement, the latter is reduced until the internal combustion engine continues to run of its own accord.

In accordance with a particularly preferred embodiment it can be provided that the fuel volume flow fed to the internal combustion engine is ascertained in accordance with the following formula:

Q_{B}=Q_{G}/(1+lambda*I ₘᵢₙ),

wherein Q_{B} corresponds to the fuel volume flow fed to the internal combustion engine, Q_{G} corresponds to a predeterminable mixture volume flow of the fuel-air mixture, lambda corresponds to a combustion air ratio of the fuel-air mixture and Iₘᵢₙ corresponds to a minimum air requirement in relation to the fuel.

The combustion air ratio lambda of the fuel-air mixture is the ratio of the mass of air actually available for combustion to the at least necessary stoichiometric mass of air necessary for complete combustion. In the case of internal combustion engines operated with air excess and thus overstoichiometrically (lambda >1) the combustion air ratio is frequently also referred to as the excess air number.

The minimum air requirement Iₘᵢₙ—which is frequently also referred to as the stoichiometric air requirement—is a mass ratio of the stoichiometric air mass to the fuel mass. The minimum air requirement Iₘᵢₙ is therefore a value which is dependent on the respective fuel used. It specifies the multiple of the given fuel mass which is needed as the air mass to permit stoichiometric combustion (with lambda =1) of the mass of fuel.

The mixture volume flow Q_{G} of the fuel air mixture can involve the value, standardised to normal pressure (1.013 bar) and normal temperature (293 Kelvin), of a mixture volume flow of the fuel-air mixture, which derives from the degree of efficiency and the intake volume per minute at a given internal combustion engine speed.

It can preferably be provided that Iₘᵢₙ is varied.

In a particularly preferred variant it can be provided that Iₘᵢₙ is reduced, preferably starting from about 10 as the starting value.

That case is relevant in particular when, by virtue of the ambient parameters, it is admittedly known at what value for the combustion air ratio lambda the internal combustion engine usually starts (for example with lambda =1.2), but the fuel quality and thus the appropriate value for the minimum air requirement Iₘᵢₙ is unknown. In that case it can be provided that, for the internal combustion engine starting operation, the value for the combustion air ratio lambda is kept constant—for example at lambda =1.2—and the value for the minimum air requirement Iₘᵢₙ is reduced, starting from the value Iₘᵢₙ=10, until the internal combustion engine starts and continues to run of its own accord. If, by the variation in the value for the minimum air requirement Iₘᵢₙ, it is established that the internal combustion engine starts for example at a value of Iₘᵢₙ=4, it is then possible in that way to arrive at a conclusion about the quality of the fuel, that is linked to that value. In particular however it is possible in that way for the starting process to be reliably implemented without the gas quality having to be known in advance. That value which is established at the start for the minimum air requirement Iₘᵢₙ—in the stated example Iₘᵢₙ=4—can also be used for further operation of the internal combustion engine as a suitable value for the minimum air requirement Iₘᵢₙ in the respective calculation formulae for fuel metering and can thus permit optimum operation of the internal combustion engine, that is adapted to the fuel quality actually involved.

Alternatively or additionally it can also be provided that lambda is varied.

In a particularly preferred variant it can be provided that lambda is reduced, preferably starting from about 2 as the starting value.

That case is relevant in particular when the fuel quality and thus the appropriate value for the minimum air requirement Iₘᵢₙ is admittedly known but, by virtue of the ambient parameters (for example the installation location of the internal combustion engine at a great height above sea level) it is not known at what value for the combustion air ratio lambda the internal combustion engine starts in the given environment. In that respect it can be provided that, for the internal combustion engine starting operation, the value for the minimum air requirement Iₘᵢₙ is kept constant corresponding to the known fuel involved and the value for the combustion air ratio lambda is reduced starting from a predeterminable starting value until the internal combustion engine starts and continues to run of its own accord, for example at a value of lambda =1.1.

In a preferred embodiment of the invention it can be provided that that parameter value of the at least one parameter which is characteristic of the energy content of the fuel-air mixture, at which the internal combustion engine continues to run of its own accord, is kept substantially constant at least for a time for further operation of the internal combustion engine. In that respect it can also be provided that that parameter value of the characteristic parameter, at which the internal combustion engine continues to run of its own accord, is kept constant for all further load conditions of the internal combustion engine.

It can also be provided that the parameter value is kept substantially constant up to a power demand to the internal combustion engine of at most 30% of a nominal load of the internal combustion engine.

Further details and advantages of the present invention will be described by means of the specific description hereinafter. In the drawing:

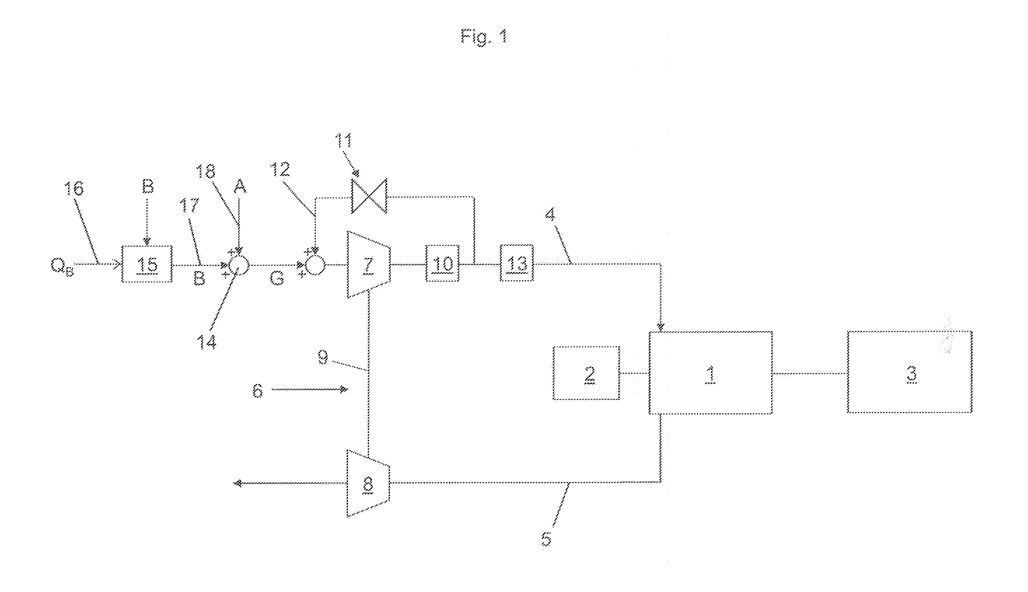

FIG. 1 shows a schematic block diagram of an internal combustion engine,

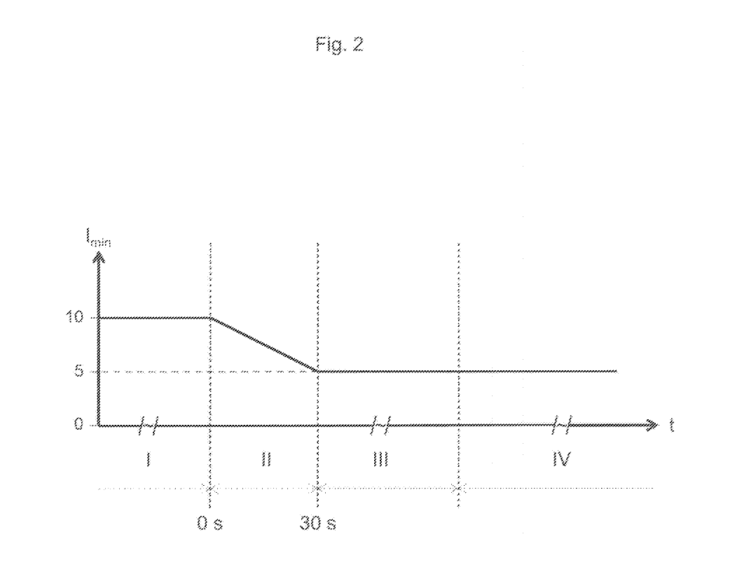

FIG. 2 shows a starting operation for an internal combustion engine in accordance with an embodiment of the proposed method, and

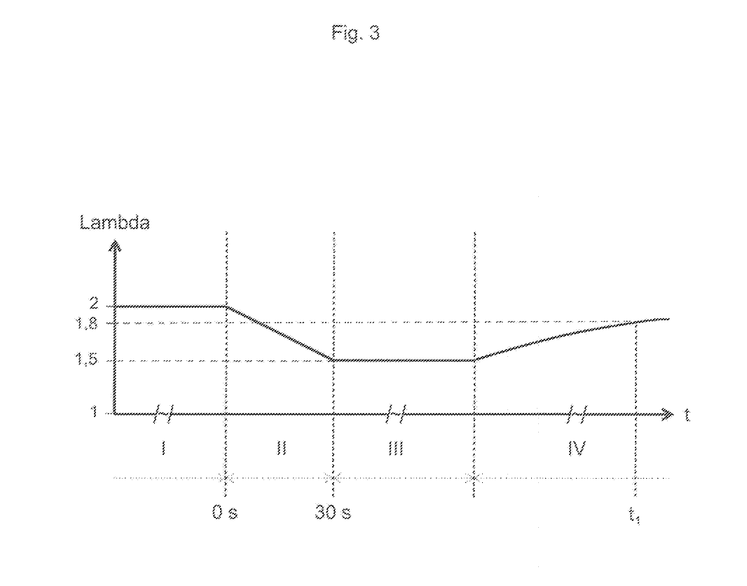

FIG. 3 shows a starting operation for an internal combustion engine in accordance with a further embodiment of the proposed method.

FIG. 1 shows a schematic block diagram of an internal combustion engine 1 in the form of a stationary gas engine. During the starting operation for the internal combustion engine 1 it is driven by a starter device 2 until the internal combustion engine 1 continues to run of its own accord. In this example the internal combustion engine 1 drives an electric generator 3 which supplies electric power to an electric power network (not shown). Arranged in a feed conduit 4 and an exhaust conduit 5 in known manner is a turbocharger 6 which includes an exhaust gas turbine 8 and a compressor 7 driven by the exhaust gas turbine 8 by way of a shaft 9. A mixture intercooler 10 is connected downstream of the compressor 7. A part of the compressed fuel-air mixture G is recycled upstream of the compressor 7 again by way of a bypass conduit 12 and a compressor bypass valve 11 disposed in the bypass conduit 12. Arranged in the feed conduit 4 upstream of the compressor 7 is a mixer 14 in which air A and fuel B are mixed to form a fuel-air mixture G which is fed to the compressor 7. After flowing through the mixture intercooler 10 and a throttle flap 13 the fuel-air mixture G is fed to the internal combustion engine 1.

An air conduit 18 for introducing air A and a fuel conduit 17 for introducing fuel B in the form of fuel gas open into the mixture 14. Arranged in the fuel conduit 17 is a fuel valve 15 for example in the form of a gas solenoid valve. The respective value for the required fuel volume flow Q_{B} in accordance with the proposed method is commanded to that fuel valve 15 by way of a signal line 16. In dependence on the commanded value for the required fuel volume flow Q_{B} the corresponding fuel volume flow Q_{B} of fuel B is provided in the fuel conduit 17 by way of the fuel valve 15.

The commanded value for the fuel volume flow Q_{B} changes during the starting operation for the internal combustion engine 1 in dependence on the variation in the at least one parameter characteristic of the energy content of the fuel-air mixture G (for example minimum air requirement Iₘᵢₙ or combustion air ratio lambda) in accordance with the proposed method.

Unlike the arrangement shown in FIG. 1 the internal combustion engine 1 can also be designed without a bypass conduit 12. Alternatively or additionally to the bypass conduit 12 a wastegate can also be arranged in the exhaust conduit 5 in the region of the exhaust gas turbine 8 in known manner.

FIG. 2 shows, for a starting operation by way of example of an internal combustion engine 1, the variation in respect of time of the minimum air requirement Iₘᵢₙ which is varied during the starting operation, in accordance with an embodiment of the proposed method. In this example four phases I, II, III, IV are shown in relation to time. Phase I corresponds to a stop phase of the internal combustion engine 1 in which it is not running. Phase II corresponds to a starting phase of the internal combustion engine 1, during which the proposed method is used. Phase III represents an idle phase or a low-load phase of the internal combustion engine 1, in which a power demand to the internal combustion engine 1 is at most 30% of a nominal load of the internal combustion engine 1. Phase IV represents a load phase of the internal combustion engine 1 with a power demand to the internal combustion engine 1 of more than 30% of the nominal load of the internal combustion engine 1. As can be seen from the graph during the start phase (phase II)—which in the illustrated example lasts for about 30 seconds—the value for the minimum air requirement Iₘᵢₙ, starting from a starting value of for example 10, is reduced until the internal combustion engine 1 starts and continues to run on its own. That value for the minimum air requirement Iₘᵢₙ, at which the internal combustion engine 1 continues to run on its own (in this example at Iₘᵢₙ=5), is kept substantially constant subsequently for further operation of the internal combustion engine 1 in phases III and IV.

FIG. 3 shows for a starting operation by way of example of an internal combustion engine 1 the variation in respect of time of the combustion air ratio lambda which is varied during the starting operation, in accordance with an embodiment of the proposed method. The time phases I, II, III, IV correspond to the corresponding phases in FIG. 2. In this example, during the starting phase (phase II) the value for the combustion air ratio lambda is reduced starting from a starting value of for example 2 until the internal combustion engine 1 starts and continues to run on its own. That value for the combustion air ratio lambda, at which the internal combustion engine 1 continues to run on its own (in this example at lambda =1.5) is kept substantially constant subsequently for the idle phase or the low-load phase (phase III) of the internal combustion engine 1. The load phase (phase IV) involves adaptation of the combustion air ratio lambda in accordance with the power required from the internal combustion engine 1. In the illustrated example the combustion air ratio lambda is increased in the load phase (phase IV) by the engine management system and at a time t₁ is about 1.8.

1. A method of starting an internal combustion engine operated with a fuel-air mixture, in particular a stationary gas engine, wherein fed to the internal combustion engine as part of the fuel-air mixture is a fuel volume flow which is ascertained having regard to at least one parameter which is characteristic of the energy content of the fuel-air mixture, wherein the internal combustion engine is driven by a starter device until the internal combustion engine continues to run of its own accord, wherein the fuel volume flow fed to the internal combustion engine is varied by a variation in the at least one parameter which is characteristic of the energy content of the fuel-air mixture until the internal combustion engine continues to run of its own accord.

2. A method as set forth in claim 1, wherein minimum air requirement is varied in relation to the fuel as the parameter which is characteristic of the energy content of the fuel-air mixture.

3. A method as set forth in claim 1, wherein a combustion air ratio of the fuel-air mixture is varied as the parameter which is characteristic of the energy content of the fuel-air mixture.

4. A method as set forth in claim 1, wherein the at least one parameter which is characteristic of the energy content of the fuel-air mixture is varied starting from a predeterminable starting value.

5. A method as set forth in claim 1, wherein the fuel volume flow fed to the internal combustion engine is ascertained in accordance with the following formula:
QB=QG/(1+lambda*lmin),
wherein QB corresponds to the fuel volume flow fed to the internal combustion engine, QG corresponds to a predeterminable mixture volume flow of the fuel-air mixture, lambda corresponds to a combustion air ratio of the fuel-air mixture and lmin corresponds to a minimum air requirement in relation to the fuel.

6. A method as set forth in claim 5, wherein lmin is varied.

7. A method as set forth in claim 5, wherein lmin is reduced, preferably starting from about 10 as the starting value.

8. A method as set forth in claim 5, wherein lambda is varied.

9. A method as set forth in claim 5, wherein lambda is reduced, preferably starting from about 2 as the starting value.

10. A method as set forth in claim 1, wherein that parameter value of the at least one parameter which is characteristic of the energy content of the fuel-air mixture, at which the internal combustion engine continues to run of its own accord, is kept substantially constant at least for a time for further operation of the internal combustion engine.

11. A method as set forth in claim 10, wherein the parameter value is kept substantially constant up to a power demand to the internal combustion engine of at most 30% of a nominal load of the internal combustion engine.
